(19) United States
(12) Patent Application Publication
(10) Pub. No.: US 2015/0322236 A1
(43) Pub. Date: Nov. 12, 2015

(54) PVC COMPOSITIONS OF HIGH IMPACT STRENGTH

(71) Applicants: Szilard CSIHONY, Gorxheimertal (DE); Yvonne HEISCHKEL, Ludwigshafen (DE); Rainer NOLTE, Limburgerhof (DE); Michael NEUß, Carlsberg (DE); Bernd DUTTRA, Haßloch (DE); Thomas FRIEDMANN, Mannheim (DE)

(72) Inventors: Szilard CSIHONY, Gorxheimertal (DE); Yvonne HEISCHKEL, Ludwigshafen (DE); Rainer NOLTE, Limburgerhof (DE); Michael NEUß, Carlsberg (DE); Bernd DUTTRA, Haßloch (DE); Thomas FRIEDMANN, Mannheim (DE)

(73) Assignee: BASF SE, Ludwigshafen (DE)

(21) Appl. No.: 14/378,689

(22) PCT Filed: Feb. 11, 2013
(86) PCT No.: PCT/EP2013/052646

§ 371 Date: Aug. 14, 2014

Related U.S. Application Data
(60) Provisional application No. 61/598,909, filed on Feb. 15, 2012.

(30) Foreign Application Priority Data
Feb. 15, 2012 (EP) 12155486.9

(51) Int. Cl. C08K 5/101; C08K 3/26; C08K 3/22; C08K 5/01

(52) U.S. Cl. CPC C08K 5/101; C08K 5/01; C08K 3/26; C08K 3/22; C08K 2003/265; C08K 2003/2241

(57) ABSTRACT

The invention relates to a composition, which comprises a chlorine containing thermoplastic polymer (PVC) as the substrate and a combination of a Fischer-Tropsch (FT)-wax with oxidized polyethylene wax.

The invention relates to a composition, which comprises a chlorine containing thermoplastic polymer (PVC) as the substrate and a combination of a Fischer-Tropsch (FT)-wax with oxidized polyethylene wax.

A preferred embodiment of the invention relates to a composition, which comprises a chlorine containing thermoplastic polymer (PVC) as the substrate and a combination of a FT-wax with oxidized polyethylene wax and high amounts of filling materials.

The problem to which the present invention relates is the preparation of a composition which comprises a chlorine containing thermoplastic polymer (PVC).

PVC can be stabilized by a range of additives. Compounds of lead, of barium, of tin, and of cadmium are particularly suitable for this purpose, but are nowadays controversial on ecological grounds (cf. Taschenbuch der Kunststoffadditive, Eds. R. Gächter and H. Müller, Carl Hanser Verlag, 3rd Edition, 1989, pages 303-311, and Kunststoff Handbuch PVC, Volume 2/1, G. W. Becker, D. Braun, Carl Hanser Verlag 1985, pages 531-538). The search is therefore continuing for effective stabilizers and stabilizer combinations and further additives devoid of disadvantageous properties. Stabilizers based on the mixture of zinc and calcium stearates are introduced continuously in PVC-formulation.

Fillers and lubricants are ingredients of PVC formulations. Lubricants such as polyethylene, paraffin or Fischer-Tropsch waxes are used to increase the output in PVC synthesis. These lubricants retard fusion (higher fusion time), by decreasing viscosity of the PVC mass. As a result the impact strength decreases. It is known that fillers, such as calcium carbonate, talc, clay, etc. have negative effect on the impact strength (Polymer Handbook, Eds. C. E. Wilkes, J. W. Summers, C. Daniels, Verlag, Carl Hanser Verlag 2005, page 499).

Oxidized polyethylene waxes are used to promote fusion (lower fusion time) by increasing the viscosity (Polymer Handbook, page 132). As a result the impact strength increases, but the output decreases.

It has surprisingly been found that the output in production machines, such as extruders, and simultaneously the impact strength of the final PVC products are increased in the event that an oxidized polyethylene wax in a combination with FT-wax is added to a chlorine containing thermoplastic polymer, such as PVC.

Therefore, the invention relates to a composition, which comprises
a) A chlorine containing thermoplastic polymer;
b) A wax as obtained by the Fischer-Tropsch synthesis (FT-wax); and, optionally,
c) At least one partially or fully oxidized polyethylene wax.

According to a preferred embodiment, a combination of a FT-wax with oxidized polyethylene wax has the additional surprising effect that the amount of inert fillers, such as calcium carbonate, can be increased in compositions containing chlorine containing thermoplastic polymers, such as PVC, without effectively reducing desirable mechanical properties of the composition, such as impact strength. This reduces the amount of chlorine-containing polymers in industrial productions and opens the path to the production of cost-effective, ecologically desirable compositions of chlorine-containing polymers.

Therefore, a preferred embodiment of the invention relates to a composition, which comprises
a) A chlorine containing thermoplastic polymer;
b) A wax as obtained by the Fischer-Tropsch synthesis (FT-wax); and
c) At least one partially or fully oxidized polyethylene wax.

A particularly preferred embodiment relates to a composition, which comprises
a) A chlorine containing thermoplastic polymer;
b) A wax as obtained by the Fischer-Tropsch synthesis (FT-wax);
c) At least one partially or fully oxidized polyethylene wax;
d) Filling materials; and
e) Further additives which are customary for the processing and stabilizing of chlorine-containing polymers.

A highly preferred embodiment of the invention relates to a composition, which comprises
a) 65.0-95.0 wt.-% of a chlorine containing thermoplastic polymer;
b) 0.01-2.0 wt.-% of a wax as obtained by the Fischer-Tropsch synthesis (FT-wax);
c) 0.01-0.5 wt.-% of at least one partially or fully oxidized polyethylene wax;
d) 5.0-35.0 wt.-% of filling materials; and, optionally,
e) 0.01-30.0 wt.-% of further additives which are customary for the processing and stabilizing of chlorine-containing polymers;
provided that the sum of the weight percentages of all components amounts to 100%.

A highly preferred embodiment of the invention relates to a composition, which comprises
a) 70.0-90.0 wt.-% of a chlorine containing thermoplastic polymer;
b) 0.01-1.5 wt.-% of a wax as obtained by the Fischer-Tropsch synthesis (FT-wax);
c) 0.01-0.3 wt.-% of at least one partially or fully oxidized polyethylene wax;
d) 5.0-25.0 wt.-% of filling materials; and, optionally,
e) 0.01-20.0 wt.-% of further additives which are customary for the processing and stabilizing of chlorine-containing polymers;
provided that the sum of the weight percentages of all components amounts to 100%.

An embodiment of first choice relates to a composition, which comprises
a) 75.0-90.0 wt.-% of PVC or a recyclate thereof;
b) 0.01-1.0 wt.-% of a wax as obtained by the Fischer-Tropsch synthesis (FT-wax);
c) 0.01-0.2 wt.-% of at least one partially or fully oxidized polyethylene wax;
d) 7.0-20.0 wt.-% of filling materials; and, optionally,
e) 0.01-10.0 wt.-% of further additives which are customary for the processing and stabilizing of chlorine-containing polymers;
provided that the sum of the weight percentages of all components amounts to 100%.

The compositions defined above are characterized by their improved mechanical properties, such as impact strength, and other advantageous properties, such as fusion times, as indication of output.

### COMPONENT A

The term chlorine-containing polymer comprises within its scope any polymer directly obtainable by the polymerization process for its production. The term also comprises within its definition worked-up polymer units or polymer fragments obtainable by standard methods for recycling, so called recyclates.

Representative examples of chlorine-containing polymers or of the recyclates thereof are: polymers of vinyl chloride, vinyl resins containing vinyl chloride units in their structure, such as copolymers of vinyl chloride and vinyl esters of aliphatic acids, especially vinyl acetate, copolymers of vinyl chloride with esters of acrylic and methacrylic acid and with acrylonitrile, copolymers of vinyl chloride with diene compounds and unsaturated dicarboxylic acids or the anhydrides thereof, such as copolymers of vinyl chloride with diethyl maleate, diethyl fumarate or maleic acid anhydride, post-chlorinated polymers and copolymers of vinyl chloride, copolymers of vinyl chloride and vinylidene chloride with unsaturated aldehydes, ketones and others, such as acrolein, crotonaldehyde, vinyl methyl ketone, vinyl methyl ether, vinyl isobutyl ether and the like; polymers of vinylidene chloride and copolymers thereof with vinyl chloride and other polymerisable compounds; polymers of vinyl chloroacetate and dichlorodivinyl ether; chlorinated polymers of vinyl acetate, chlorinated polymeric esters of acrylic acid and alpha-substituted acrylic acid; polymers of chlorinated styrenes, for example dichlorostyrene; chlorinated gum; chlorinated polymers of ethylene, polymers and post-chlorinated polymers of chlorobutadiene and the copolymers thereof with vinyl chloride, gum hydrochloride and chlorinated gum hydrochloride; and mixtures of the mentioned polymers with one another or with other polymerisable compounds.

Also included are the graft polymers of PVC with EVA, ABS and MBS. Preferred substrates are also mixtures of the above-mentioned homo- and co-polymers, especially vinyl chloride homopolymers, with other thermoplastic and/or elastomeric polymers, especially blends with ABS, MBS, NBR, SAN, EVA, CPE, MBAS, PMA, PMMA, EPDM and polylactones.

Preference is given also to suspension and bulk polymers, and to emulsion polymers.

Polyvinyl chloride is especially preferred as the chlorine-containing polymer, especially in the form of a suspension polymer and of a bulk polymer.

Within the scope of this invention, PVC is also to be understood to include copolymers or graft polymers of PVC with polymerisable compounds such as acrylonitrile, vinyl acetate or ABS, which may be suspension, bulk or emulsion polymers. Preference is given to PVC-homopolymers also in combination with polyacrylates.

Within the scope of this invention are especially recyclates of chlorine-containing polymers, the polymers being those described in detail above, which have been damaged as a result of processing, use or storage. PVC recyclate is especially preferred. The recyclates may also contain small amounts of foreign substances, such as paper, pigments and adhesives, which are often difficult to remove. Those foreign substances may also originate from contact with various substances during use or working-up, such as propellant residues, traces of lacquer, traces of metal, and initiator radicals.

### COMPONENT B

Suitable waxes as obtained by the Fischer-Tropsch synthesis, so-called Fischer-Tropsch or FT-waxes, are white, translucent, tasteless and odourless solids and consist of a mixture of solid hydrocarbons of high molecular weight. FT-waxes consist essentially of 40 and 80 carbon atoms and an average molar mass between 600 g/mol and 1300 g/mol. The waxes have a fine crystalline structure and, because of the narrow mass distribution, a small melting range and low melt viscosities.

Suitable waxes are slightly soluble in benzene, ligroin, warm alcohol, chloroform and carbon disulphide, but insoluble in warm water and acids. Their density is approximately 0.92-0.96 g/cm³, melting point 80-115° C., congealing point 80-110° C. and viscosity at 135° C. between 10 and 200 [mPa·s]. Common properties are water repellency, smooth texture, low toxicity, and absence of objectionable odours and colours.

The amount of paraffin waxes as obtained by the Fischer-Tropsch synthesis in the compositions as claimed is from about 0.01-1.5%, preferably 0.01-1%.

### COMPONENT C

Suitable partially or fully oxidized polyethylene waxes may be prepared by high pressure polymerization of ethylene with radical process without catalyst or by middle or low pressure polymerization of ethylene by using a wide variety of suitable catalysts, such as so-called Ziegler, Phillips or metallocene catalysts, in the optional presence of polymerisation regulators, and subsequent oxidation reaction of the polyethylene wax obtained.

Suitable polyethylene waxes, which optionally can be cross linked, are selected from the group consisting of, for example, high density polyethylene (HDPE), high density and high molecular weight polyethylene (HDPE-HMW), high density and ultra-high molecular weight polyethylene (HDPE-UHMW), medium density polyethylene (MDPE), low density polyethylene (LDPE), linear low density polyethylene (LLDPE), VLDPE and ULDPE.

Low density polyethylene (LDPE) is preferred. LDPE is partially (about 40-60%) crystalline solid, melting between 95-115° C., with a density in the range of about 0.92-0.96 g/cm³.

The expression “polyethylene” is not confined to homopolymers of ethylene, but also comprises copolymers of ethylene with other olefins, such as propylene, 1-butene, 1-pentene, 1-hexene, 1-octene or isobutene or with other ethylenically unsaturated mono- or dicarboxylic acids, such as (meth)acrylic acid.

Suitable polyethylene waxes have a density from about 0.90-0.98 g/cm³ and a molecular weight from about 500-40 000 g/mol, preferably 3 000-20 000 g/mol.

Suitable oxidizing agents are oxygen or oxygen-containing gases. Air is preferably used for oxidation. The oxidizing gas is either blown into the polymer mixture obtained or injected into the polymer mixture.

For the oxidation reaction it is preferred to establish a constant stream of oxygen from about 0.1-100 l·⁻¹·kg wax⁻¹, preferably from 1-10 l·h^{<1}·kg wax⁻¹.

The oxidation reaction is normally conducted in a tubular reactor. The reaction temperature during oxidation is from about 120-250° C., preferably from about 140-200° C. The reaction pressure is set at from about 5-200 bar.

Partially oxidized polyethylene waxes have an acid number in the range from about 10-100 mg KOH/g preferably 10-50 mg KOH/g, as determined in accordance with DIN 53402 and a hydrolysis number in the range from 10-70 mg KOH/g, as determined in accordance with DIN 53401.

The amount of partially or fully oxidized polyethylene waxes in the compositions as claimed is from about 0.01-0.3%, preferably 0.01-0.2 wt.-%.

### COMPONENT D

Examples of suitable fillers or reinforcing agents are listed in Handbook of PVC-Formulating edited by E. J. Wickson, John Wiley & Sons, New York 1993, pp. 393-449 or in Taschenbuch der Kunststoffadditive”, Editors R. Gächter and H. Müller, Carl Hanser Verlag, 3rd Edition, 1989, pages 549-615.

Suitable fillers are based on minerals commonly found in nature, such as aluminium oxides, alumino silicates, calcium sulphate, barium sulphate, titanium oxide, calcium carbonate, dolomite, wollastonite, magnesium oxide, magnesium hydroxide, silicates, phosphates, talc, kaolin, chalk, mica, or other metal oxides and metal hydroxides. Preference is being given to calcium carbonate.

Other fillers or reinforcing agents derived from the minerals mentioned above, such as carbon black or graphite or glass fibre materials, are also possible.

The amount of fillers or reinforcing agents in the compositions as claimed is from about 5.0-25.0 wt.-%, preferably 7.0 20.0 wt.-%.

According to a preferred embodiment of the invention, the amount of fillers or reinforcing agents can be increased up to 35.0 wt.-%, preferably up to 30.0 wt.-%.

### COMPONENT E

The composition as defined above contains as optional components further additives which are customary for the processing and stabilizing of chlorine-containing polymers. PVC can be stabilized by a range of additives. Compounds of lead, of barium and of cadmium are particularly suitable for this purpose, but are nowadays controversial on ecological grounds, cf. the above-mentioned, see Taschenbuch der Kunststoffadditive, and Kunststoff Handbuch PVC, pages 531-538. Preferred are effective stabilizers and stabilizer combinations devoid of disadvantageous properties, such as a mixture of calcium and zinc stearate or organic stabilizers.

The further additives can be used in an amount of, for example, from 0.01-50 parts by weight, preferably from 0.01-30 parts by weight, in particular from 0.01-10 parts by weight, based on 100 parts by weight of the polymer component a). If fillers are used, the upper limits stated can also be exceeded and, for example, up to 80 parts by weight of further additives can be used.

Suitable additives which are customary for the processing and stabilizing of chlorine-containing polymers are selected from the group consisting of epoxides and epoxidized fatty acid esters, phosphites, thiophosphites and thiophosphates, polyols, 1,3-dicarbonyl compounds, mercaptocarboxylic esters, dihydropyridines and polydihydropyridines, antioxidants; light stabilizers and UV absorbers, alkali metal and alkaline earth metal compounds, perchlorate salts, zeolites, hydrotalcites and dawsonites.

Further additives which are customary for the processing and stabilizing of chlorine-containing polymers are selected from the group consisting of lubricants; plasticizers; impact modifiers; processing aids; blowing agents; antistats; biocides; antifogging agents; pigments and dyes; metal deactivators and flame proofing agents, cf. in this respect the above-mentioned Handbook of PVC Formulating.

Examples of such additives are known to the skilled worker and can be found in the technical literature. Without limitation, some representative additives and processing aids are listed below:

### Epoxides and Epoxidized Fatty Acid Esters

Suitable epoxides and epoxidized fatty acid esters contain the glycidyl group

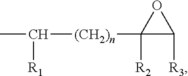

which is bonded directly to carbon, oxygen, nitrogen or sulphur atoms and wherein either R₁ and R₃ are both hydrogen, R₂ is hydrogen or methyl and n=0, or R₁ and R₃ together are —CH₂—CH₂— or —CH₂—CH₂—CH₂—, in which case R₂ is hydrogen and n=0 or 1.

Suitable glycidyl compounds are glycidyl and β-methylglycidyl esters obtainable by reacting a compound having at least one carboxy group in the molecule with epichlorohydrin or glycerol dichlorohydrin or β-methyl-epichlorohydrin. The reaction is advantageously carried out in the presence of bases.

Glycidyl or (β-methylglycidyl) ethers obtainable by reacting a compound having at least one free alcoholic hydroxy group and/or phenolic hydroxy group and a suitably substituted epichlorohydrip under alkaline conditions, or in the presence of an acid catalyst with subsequent treatment with an alkali.

Ethers of that type are derived, for example, from acyclic alcohols, such as ethylene glycol, diethylene glycol and higher poly(oxyethylene) glycols, propane-1,2-diol, or poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylolpropane, bistrimethylolpropane, pentaerythritol, sorbitol, and from polyepichlorohydrins, n-butanol, amyl alcohol, pentanol, and from monofunctional alcohols, such as isooctanol, 2-ethylhexanol, isodecanol and C₇-C₉alkanol and C₉-C₁₁alkanol mixtures.

They are, however, also derived, for example, from cycloaliphatic alcohols, such as 1,3- or 1,4-dihydroxycyclohexane, bis(4-hydroxycyclohexyl)methane, 2,2-bis(4-hydroxycyclohexyl)propane or 1,1-bis(hydroxymethyl)cyclohex-3-ene, or they have aromatic nuclei, such as N,N-bis(2-hydroxyethyl)aniline or p,p′-bis(2-hydroxyethylamino)diphenylmethane.

The epoxide compounds can also be derived from mononuclear phenols, such as phenol, resorcinol or hydroquinone, or they are based on poly-nuclear phenols, such as bis(4-hydroxyphenyl)methane, 2,2-bis(4-hydroxyphenyl)propane, 2,2-bis(3,5-dibromo-4-hydroxyphenyl)propane, 4,4′-dihydroxydiphenylsulphone, or on condensation products of phenols with formaldehyde obtained under acid conditions, such as phenol novolaks.

N-Glycidyl compounds obtainable by dehydrochlorinating the reaction products of epichiorohydrin with amines containing at least one aminohydrogen atom. Those amines are, for example, aniline, N-methyl aniline, toluidine, n-butylamine, bis(4-aminophenyl)methane, m-xylylenediamine or bis(4-methylaminophenyl)methane, but also N,N,O-triglycidyl-m-aminophenol or N,N,O-triglycidyl-p-aminophenol.

The N-glycidyl compounds also include, however, N,N′-di-, N,N′,N″-tri- and N,N′,N″,N′″-tetraglycidyl derivatives of cycloalkylene ureas, such as ethylene urea or 1,3-propylene urea, and N,N′-diglycidyl derivatives of hydantoins, such as 5,5-dimethylhydantoins, or glycoluril and triglycidyl isocyanurate.

S-Glycidyl compounds, such as di-S-glycidyl derivatives, that are derived from dithiols, such as ethane-1,2-dithiol or bis(4-mercaptomethylphenyl) ether.

Epoxide compounds containing a radical of formula I wherein R₁ and R₃ together are —CH₂—CH₂— and n is 0 are bis(2,3-epoxycyclopentyl) ether, 2,3-epoxycyclopentylglycidyl ether or 1,2-bis(2,3-epoxycyclopentyloxy)ethane. An epoxy resin containing a radical of formula I wherein R₁ and R₃ together are —CH₂—CH₂— and n is 1 is, for example, 3,4-epoxy-6-methylcyclohexanecarboxylic acid (3′,4′-epoxy-6′-methylcyclohexyl)-methyl ester.

Suitable terminal epoxides are, for example (™ denotes 0):
a) Liquid diglycidyl ethers of bisphenol A, such as Araldite™GY 240, GY 250, GY 260, GY 266, GY 2600, MY 790;
b) Solid diglycidyl ethers of bisphenol A, such as Araldite™GT 6071, GT 7071, GT 7072, GT 6063, GT 7203, GT 6064, GT 7304, GT 7004, GT 6084, GT 1999, GT 7077, GT 6097, GT 7097, GT 7008, GT 6099, GT 6608, GT 6609, GT 6610;
c) Liquid diglycidyl ethers of bisphenol F, such as Araldite™GY 281, PY 302, PY 306;
d) Solid polyglycidyl ethers of tetraphenylethane, such as CG Epoxy Resin™0163;
e) Solid and liquid polyglycidyl ethers of phenol formaldehyde novolak, such as EPN 1138, EPN 1139, GY 1180, PY 307;
f) Solid and liquid polyglycidyl ethers of o-cresol formaldehyde novolak, such as ECN 1235, ECN 1273, ECN 1280, ECN 1299;
g) Liquid glycidyl ethers of alcohols, such as Shell® glycidyl ether 162, Araldite™DY 0390, DY 0391;
h) Liquid glycidyl ethers of carboxylic acids, such as Shell™Cardura E terephthalic acid ester, trimellitic acid ester, Araldite™PY 284;
i) Solid heterocyclic epoxy resins (triglycidyl isocyanurate), such as Araldite™PT 810;
k) Liquid cycloaliphatic epoxy resins, such as Araldite™CY 179;
l) Liquid N,N,O-triglycidyl ethers of p-aminophenol, such as Araldite™MY 0510;
m) Tetraglycidyl-4,4′-methylenebenzamine or N,N,N′,N′-tetraglycidyl-diaminophenylmethane, such as Araldite™MY 720, MY 721.

Preference is given to the use of epoxide compounds having two functional groups. It is also possible to use epoxide compounds having one, three or more functional groups.

There are used predominantly epoxide compounds, especially diglycidyl compounds, having aromatic groups.

Where appropriate, a mixture of different epoxide compounds can also be used.

Further examples are epoxidized linseed oil, epoxidized fish oil, epoxidized tallow, methylbutyl or 2-ethylhexyl epoxystearate, tris(epoxypropyl)isocyanurate, epoxidized castor oil, epoxidized sunflower oil, 3-phenoxy-1,2-epoxypropane, bisphenol A diglycidyl ether, vinylcyclohexene diepoxide, dicyclopentadiene diepoxide and 3,4-epoxycyclohexylmethyl 3,4-epoxycyclohexanecarboxylate.

Especially preferred as terminal epoxide compounds are diglycidyl ethers based on bisphenols, such as 2,2-bis(4-hydroxyphenyl)propane (bisphenol A), bis(4-hydroxyphenyl)-methane or mixtures of bis(ortho/para-hydroxyphenyl)methane (bisphenol F).

### Phosphites

Suitable phosphites are known co-stabilizers for chlorine-containing polymers. Examples are trioctyl, tridecyl, tridodecyl, tritridecyl, tripentadecyl, trioleyl, tristearyl, triphenyl, tricresyl, trisnonylphenyl, tris-2,4-t-butylphenyl or tricyclohexyl phosphite.

Further suitable phosphites are various mixed aryl dialkyl and alky diarylphosphites, such as phenyl dioctyl, phenyl didecyl, phenyl didodecyl, phenyl ditridecyl, phenylditetradecyl, phenyl dipentadecyl, octyl diphenyl, decyl diphenyl, undecyl diphenyl, dodecyldiphenyl, tridecyl diphenyl, tetradecyl diphenyl, pentadecyl diphenyl, oleyl diphenyl, stearyl diphenyl and dodecyl bis-2,4-di-t-butylphenyl phosphite.

Furthermore, phosphites of various diols and polyols can also be used advantageously; examples are tetraphenyldipropylene glycol diphosphite, polydipropylene glycol phenyl phosphite, tetramethylolcyclohexanol decyl diphosphite, tetramethylolcyclohexanol butoxyethoxyethyl diphosphite, tetramethylolcyclohexanol nonylphenyl diphosphite, bisnonylphenyl di-trimethylolpropane diphosphite, bis-2-butoxyethyl di-trimethylolpropane diphosphite, trishydroxyethyl isocyanurate hexadecyl triphosphite, didecylpentaerythritol diphosphite, distearyl pentaerythritol diphosphite, bis-2,4-di-t-butylphenyl pentaerythritol diphosphite, and also mixtures of these phosphites and aryl/alkyl phosphite mixtures of the statistical composition (H₁₉C₉-C₆H₄)O_{1.5}P(OC_{12,13}H_{25,27})_{1.5} or [C₈H₁₇—C₆H₄—O-]₂P[i-C₈H₁₇O] or (H₁₉C₉-C₆H₄)O_{1.5}P (OC_{9,11}H_{19,23})_{1.5}.

### Thiophosphites and Thiophosphates

Suitable thiophosphites and thiophosphates are compounds of the general formula: (RS)₃P, (RS)₃P=0 and (RS)₃P═S, as described in the patent literature DE 2 809 492, EP 090 770 and EP 573 394. Examples are: trithiohexyl phosphite, trithiooctyl phosphite, trithiolauryl phosphite, trithiobenzyl phosphite, tris[carboxy-i-octyloxy]methyl trithiophosphate, S,S,S-tris[carbo-i-octyloxy]methyl trithiophosphate, S,S,S-tris[carbo-2-ethylhexyloxy]methyl trithiophosphate, S,S,S,-tris-1-[carbohexyloxy]ethyl trithiophosphate, S,S,S-tris-1-[carbo-2-ethylhexyloxy]ethyl trithiophosphate, S,S,S-tris-2-[carbo-2-ethylhexyloxy]ethyl trithiophosphate.

### Polyols

Examples of suitable compounds of this type are: pentaerythritol, dipentaerythritol, tripentaerythritol, bistrimethylolpropane, trimethylolethane, bistrimethylolethane, trimethylolpropane, sorbitol, maltitol, isomaltitol, lactitol, lycasine, mannitol, lactose, leucrose, tris(hydroxyethyl) isocyanurate, palatinite, tetramethylolcyclohexanol (TMCH), tetramethylolcyclopentanol, tetramethylolcyclopyranol, glycerol, diglycerol, polyglycerol, thiodiglycerol, or 1-O-α-D-glycopyranosyl-D-mannitol dihydrate, and also polyvinyl alcohol and cyclodextrins. Among these, TMCH and the disaccharide alcohols are preferred.

### 1,3-Dicarbonyl Compounds

Examples of 1,3-dicarbonyl compounds are acetylacetone, butanoylacetone, heptanoylacetone, stearoylacetone, palmitoylacetone, lauroylacetone, 7-tert-nonylthioheptane-2,4-dione, benzoylacetone, dibenzoylmethane, lauroylbenzoylmethane, palmitoylbenzoylmethane, stearoylbenzoylmethane, isooctylbenzoylmethane, 5-hydroxycapronylbenzoylmethane, tribenzoylmethane, bis(4-methylbenzoyl)methane, benzoyl-p-chlorobenzoylmethane, bis(2-hydroxybenzoyl)methane, 4-methoxybenzoyl-benzoylmethane, bis(4-methoxybenzoyl)methane, 1-benzoyl-1-acetylnonane, benzoyl-acetylphenylmethane, stearoyl-4-methoxybenzoylmethane, bis(4-tert-butylbenzoyl)methane, benzoylformylmethane, benzoylphenylacetylmethane, bis(cyclohexanoyl)methane, di(pivaloyl)methane, acetoacetic methyl, ethyl, hexyl, octyl, dodecyl or octadecyl ester, benzoylacetic ethyl, butyl, 2-ethyihexyl, dodecyl or octadecyl ester, stearoylacetic ethyl, propyl, butyl, hexyl or octyl ester and dehydroacetic acid, and the zinc, alkali metal, alkaline earth metal or aluminium salts thereof.

### Mercaptocarboxylic Esters

Examples of these compounds are: esters of thioglycolic acid, thiomalic acid, mercaptopropionic acids, of mercaptobenzoic acids and of thiolactic acid, as are described in FR 2 459 816, EP 90 748, FR 2 552 440 and EP 365 483. The mercaptocarboxylic esters also embrace corresponding polyol esters and their partial esters.

They can be present in the chlorine-containing polymer expediently in proportions of from 0.01-10.0%, preferably from 0.1-5.0% and, in particular, from 0.1-1.0%, based on the weight of the polymer.

### Dihydropyridines and Polydihydropyridines

Suitable monomeric dihydropyridines are compounds as described, for example, in FR 2 039 496, EP 362 012 and EP 24 754. Preference is given to those of the formula

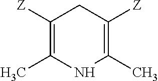

in which Z is
CO₂CH₃, CO₂C₂H₅, CO₂ⁿC₁₂H₂₅ or —CO₂C₂H₄—S—ⁿC₁₂H₂₅ in which n is zero or a numeral from 1-20.

Particularly suitable polydihydropyridines are compounds of the following formula

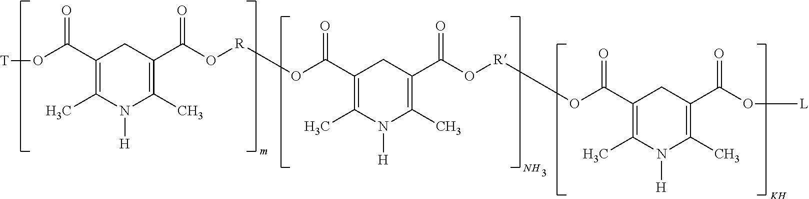

in which T is unsubstituted C₁₋₁₂alkyl,
L is as defined for T,
m and n are numbers from 0-20,
k is 0 or 1,
R and R′ independently of one another are ethylene, propylene, butylene or an alkylene- or cycloalkylenebismethylene group of the type —(—CₚH₂ₚ—X—)ₜCₚH₂ₚ—,
p is from 2-8,
t is from 0-10, and
X is oxygen or sulphur.
Compounds of this kind are described in more detail in EP 0 286 887.

Particular preference is given to thiodiethylenebis[5-methoxycarbonyl-2,6-dimethyl-1,4-dihydropyridine-3-carboxylate].

### Antioxidants; Light Stabilizers and UV Absorbers

Preferred specific antioxidants include octadecyl 3-(3,5-di-tert-butyl-4-hydroxyphenyl) propionate (IRGANOX 1076), pentaerythritol-tetrakis[3-(3,5-di-tert-butyl-4-hydroxyphenyl)propionate] (IRGANOX 1010), tris(3,5-di-tert-butyl-4-hydroxyphenyl)isocyanurate (IRGANOX 3114), 1,3,5-trimethyl-2,4,6-tris(3,5-di-tert-butyl-4-hydroxybenzyl)benzene (IRGANOX 1330), triethyleneglycol-bis[3-(3-tert-butyl-4-hydroxy-5-methylphenyl)propionate] (IRGANOX 245), and N,N′-hexane-1,6-diyl-bis[3-(3,5-di-tert-butyl-4-hydroxyphenyl)propionamide] (IRGANOX 1098), tris(2,4-di-tert-butylphenyl)phosphite (IRGAFOS 168), 3,9-bis(2,4-di-tert-butylphenoxy)-2,4,8,10-tetraoxa-3,9-diphosphaspiro[5.5]undecane (IRGAFOS 126), 2,2′,2″-nitrilo[triethyl-tris(3,3′,5,5′-tetra-tert-butyl-1,1′-biphenyl-2,2′-diyl)]phosphite (IRGAFOS 12), and tetrakis(2,4-di-tert-butylphenyl)[1,1-biphenyl]-4,4′-diylbisphosphonite (IRGAFOS P-EPQ). Specific light stabilizers include 2-(2H-benzotriazole-2-yl)-4,6-bis(1-methyl-1-phenylethyl)phenol (TINUVIN 234), 2-(5-chloro(2H)-benzotriazole-2-yl)-4-(methyl)-6-(tert-butyl)phenol (TINUVIN 326), 2-(2H-benzotriazole-2-yl)-4-(1,1,3,3-tetramethylbutyl)phenol (TINUVIN 329), 2-(2H-benzotriazole-2-yl)-4-(tert-butyl)-6-(secbutyl)phenol (TINUVIN 350), 2,2′-methylenebis(6-(2H-benzotriazol-2-yl)-4-(1,1,3,3-tetramethylbutyl)phenol) (TINUVIN 360), and 2-(4,6-diphenyl-1,3,5-triazin-2-yl)-5-[(hexyl)oxy]-phenol (TINUVIN 1577), 2-(2′-hydroxy-5′-methylphenyl)benzotriazole (TINUVIN P), 2-hydroxy-4-(octyloxy)benzophenone (CHIMASSORB 81), 1,3-bis-[(2′-cyano-3′,3′-diphenylacryloyl)oxy]-2,2-bis-{[(2′-cyano-3′,3′-diphenylacryloyl)oxy]methyl}-propane (UVINUL 3030, BASF), ethyl-2-cyano-3,3-diphenylacrylate (UVINUL 3035, BASF), and (2-ethylhexyl)-2-cyano-3,3-diphenylacrylate (UVINUL 3039, BASF).

### Alkali Metal and Alkaline Earth Metal Compounds

By these terms are meant principally the carboxylates of the above-described acids, or also corresponding oxides and hydroxides, carbonates or basic carbonates. Also suitable are mixtures thereof with organic acids. Examples are NaOH, KOH, CaO, Ca(OH₂), MgO, Mg(OH)₂, CaCO₃, MgCO₃, dolomite, huntite, and also Na, K, Ca or Mg salts of fatty acids.

In the case of carboxylates of alkaline earth metals and of Zn, it is also possible to employ adducts thereof with MO or M(OH)₂ (M=Ca, Mg, Sr or Zn), so-called overbased compounds.

Preference is given to the use of alkali metal, alkaline earth metal and/or aluminium carboxylates, for example Na, K, Ca or aluminium stearates.

### Perchlorate Salts

Examples are those of the formula M(ClO₄)ₙ where M is Li, Na, K, Mg, Ca, Ba, Zn, Al, Ce or La. The index n is, in accordance with the valency of M, 1, 2 or 3. The perchlorate salts can be present as complexes with alcohols or ether alcohols. In this context, the respective perchlorate can be employed in various common forms in which it is supplied; for example as a salt or aqueous solution applied to a carrier material such as PVC, Ca silicate, zeolites or hydrotalcites, or obtained by chemical reaction of hydrotalcite with perchloric acid.

### Hydrotalcites and Zeolites

The chemical composition of these compounds is known to the skilled worker, for example from the patent literature, such as DE 3 843 581, U.S. Pat. No. 4,000,100, EP 062 813, WO 93/20135.

Representative examples of hydrotalcites are

Al₂O₃.6 MgOCO₂.12 H₂O, Mg_{4.5}Al₂.(OH)₁₃CO₃-3.5 H₂O, 4 MgOAl₂O₃CO₂.9 H₂O, 4 MgO.Al₂O₃CO₂.6 H₂O, ZnO.3 MgO.Al₂O₃CO₂.8-9H₂O and ZnO-3 MgO.Al₂O₃CO₂.5-6H₂O.

Examples of zeolites are sodium alumosilicates of the formulae
Na₁₂Al₁₂Si₁₂O₄₈ 27H₂O [zeolite A], Na₆Al₆Si₆O₂₄2 NaX 7.5 H₂O, X═OH, halogen, ClO₄[sodalite];
Na₆Al₆Si₃₀O₇₂ 24H₂O; Na₈Al₈Si₄₀O₉₆ 24H₂O; Na₁₆Al₁₆Si₂₄O₈₀ 16H₂O; Na₁₆Al₁₆Si₃₂O₉₆ 16H₂O;
Na₅₆Al₅₆Si₁₃₆O₃₈₄ 250H₂O [zeolite Y], Na₈₆Al₃₆Si₁₀₆O₃₈₄ 264H₂O [zeolite X];
   or the zeolites which can be prepared by partial or complete exchange of the Na atoms by Li, K, Mg, Ca, Sr or Zn atoms, such as
(Na, K)₁₀Al₁₀Si₂₂O₆₄ 20H₂O; Ca_{4.5}Na₃[(AlO₂)₁₂(SiO₂)₁₂] 30 H₂O; K₉Na₃[(AlO₂)₁₂ (SiO₂)₁₂]27 H₂O.
   Other suitable zeolites are:
Na₂OAl₂O₃(2-5)SiO₂(3.5-10) H₂O [zeolite P],
Na₂OAl₂O₃2SiO₂(3.5-10)H₂O (zeolite MAP)
   or the zeolites which can be prepared by partial or complete exchange of the Na atoms by Li, K or H atoms, such as
   (Li, Na, K, H)₁₀Al₁₀Si₂₂O₆₄20H₂O, K₉Na₃[(AlO₂)₁₂ (sio₂)₁₂]27 H₂O, K₄Al₄Si₄O₁₆6H₂O[zeolite K—F], Na₈Al₈Si₄₀O₉₆.24 H₂O zeolite D, as described in Barrer et al., J. Chem. Soc. 1952, 1561-71, and in U.S. Pat. No. 2,950,952;

Preference is given to Na-zeolite A and Na-zeolite P.

The hydrotalcites and zeolites can be naturally occurring minerals or synthetically prepared compounds.

### Dawsonites (Alkali Metal Alumocarbonates)

These compounds can be represented by the formula

{(M₂O)ₘ(Al₂O₃)ₙZₒpH₂O},

in which M is H, Li, Na, K, Mg_{1/2}, Ca_{1/2}, Sr_{1/2} or Zn_{1/2}; Z is CO₂, SO₂, (Cl₂O₇)_{1/2}, B₄O₆, S₂O₂ (thiosulphate) or C₂O₂ (oxalate); m, if M is Mg_{1/2} or Ca_{1/2}, is a number between 1 and 2, in all other cases a number between 1 and 3; n is a number between 1 and 4; or is a number between 2 and 4; and p is a number between 0 and 30.

The alumo salt compounds of the formula above can be naturally occurring minerals or synthetically prepared compounds. The metals can be partially substituted by one another. The above-mentioned alumo salt compounds are crystalline, partially crystalline or amorphous or can be present in the form of a dried gel. A process for preparing such compounds is specified in EP 394 670. Examples of naturally occurring alumo salt compounds are indigirite, tunisite, alumohydrocalcite, para-alumohydrocalcite, strontiodresserite and hydro-strontiodresserite. Further examples of alumo salt compounds are potassium alumocarbonate

{(K₂O).(Al₂O₃).(CO₂)₂.2H₂O}, sodium alumothiosulphate {(Na₂O).(Al₂O₃).(S₂O₂)₂.2H₂O}, potassium alumosulphite {(K₂O).(Al₂O₃).(SO₂)₂.2H₂O}, calcium alumooxalate {(CaO).(Al₂O₃).(C₂O₂)₂.5H₂O}, magnesium alumotetraborate {(MgO).(Al₂O₃).(B₄O₆)₂.5H₂O}, {([Mg_{0.2}Na_{0.6}]₂O).(Al₂O₃).(CO₂)₂.4.1H₂O}, {([Mg_{0.2}Na_{0.6}]₂O).(Al₂O₃).(CO₂)₂.4.3H₂O} and {([Mg_{0.3}Na_{0.4}]₂O).(Al₂O₃).(CO₂)_{2.2}.4.9H₂O}.

Preferred alumo salt compounds are those of the above formula in which M is Na or K; Z is CO₂, SO₂ or (Cl₂O₇)_{1/2}; m is 1-3; n is 1-4; o is 2-4 and p is 0-20. Z is particularly preferably CO₂.

Particular preference is given to sodium alumodihydroxycarbonate (DASC) and the homologous potassium compound (DAPC).

The composition according to the invention contains as optional components further additives which are customary for the processing and stabilizing of chlorine-containing polymers. These additives are selected from the group consisting of lubricants; plasticizers; impact modifiers; processing aids; blowing agents; antistats; biocides; antifogging agents; pigments and dyes; metal deactivators and flameproofing agents.

Examples of such additives are known to the skilled worker and can be found in the technical literature. Without limitation, some representative additives and processing aids are listed below:

### Lubricants

Examples of suitable lubricants are: montan waxes, fatty alcohols, fatty acid esters, fatty acid amides, fatty acid salts, PE waxes, amide waxes, chlorinated paraffins, glycerol esters or alkaline earth metals soaps, such as calcium stearate, and silicone-based lubricants as described in EP 0 225 261. Lubricants which can be used are also described in the above-mentioned Taschenbuch der Kunststoffadditive.

Suitable lubricants are, in particular, tin salts or preferably calcium, zinc, magnesium or aluminium salts from the series consisting of aliphatic saturated C₂-C₃₆carboxylates, aliphatic olefinic C₃-C₃₆carboxylates, aliphatic C₂-C₃₆carboxylates which are substituted by at least one OH group, cyclic or bicyclic C₅-C₂₂carboxylates, aromatic C₇-C₂₂carboxylates, aromatic C₇-C₂₂carboxylates which are substituted by at least one OH group, C₁-C₁₆alkyl-substituted phenylcarboxylates and phenyl-C₁-C₁₆alkylcarboxylates, preference being given to behenates, in particular stearates, oleates and laurates.

Very particular preference is given to calcium stearate, zinc octanoate, zinc oleate, zinc stearate and zinc laurate.

The metal salt of a fatty acid can, if desired, also be a mixture of said compounds.

### Plasticizers

Representative examples of suitable plasticizers are those from the following groups:

A) Phthalic esters

Examples of such plasticizers are dimethyl, diethyl, dibutyl, dihexyl, di-2-ethylhexyl, di-n-octyl, di-isooctyl, di-isononyl, di-isodecyl, di-isotridecyl, dicyclohexyl, di-methylcyclohexyl, dimethylglycol, dibutylglycol, benzyl butyl and diphenyl phthalate, and also mixtures of phthalates, such as C₇₋₉— and C₉₋₁₁ alkyl phthalates from predominantly linear alcohols, C₆₋₁₀-n-alkyl phthalates and C₈₋₁₀-n-alkyl phthalates. Among these, preference is given to dibutyl, dihexyl, di-2-ethylhexyl, di-n-octyl, di-isooctyl, di-isononyl, di-isodecyl, di-isotridecyl and benzyl butyl phthalate and to the abovementioned mixtures of alkyl phthalates. Particular preference is given to di-2-ethylhexyl, di-isononyl and di-isodecyl phthalate, which are also known under the common abbreviations DOP (dioctyl phthalate, di-2-ethylhexyl phthalate), DINP (diisononyl phthalate), and DIDP (diisodecyl phthalate).

B) Esters of aliphatic dicarboxylic acids, especially esters of adipic, azelaic and sebacic acid

Examples of such plasticizers are di-2-ethylhexyl adipate, di-isooctyl adipate (mixture), diisononyl adipate (mixture), di-isodecyl adipate (mixture), benzyl butyl adipate, benzyl octyl adipate, di-2-ethylhexyl azelate, di-2-ethylhexyl sebacate and di-isodecyl sebacate (mixture). Preference is given to di-2-ethylhexyl adipate and di-isooctyl adipate.

C) Trimellitic esters,

for example tri-2-ethylhexyl trimellitate, tri-isodecyl trimellitate (mixture), tri-isotridecyl trimellitate, tri-isooctyl trimellitate (mixture) and also tri-C₆₋₈alkyl, tri-C₆₋₁₀alkyl, tri-C₇₋₉alkyl and tri-C₉₋₁₁alkyl trimellitates. The latter trimellitates are formed by esterification of trimellitic acid with the corresponding mixtures of alkanols. Preferred trimellitates are tri-2-ethylhexyl trimellitate and the abovementioned trimellitates from alkanol mixtures. Common abbreviations are TOTM (trioctyl trimellitate, tri-2-ethylhexyl trimellitate), TIDTM (triisodecyl trimellitate) and TITDTM (triisotridecyl trimellitate).

D) Epoxy plasticizers

These are principally epoxidized unsaturated fatty acids such as epoxidized soybean oil.

E) Polymer plasticizers

The most common starting materials for the preparation of the polyester plasticizers are: dicarboxylic acids such as adipic, phthalic, azelaic and sebacic acid; and diols such as 1,2-propanediol, 1,3-butanediol, 1,4-butanediol, 1,6-hexanediol, neopentylglycol and diethylene glycol.

F) Phosphoric esters

Examples of such phosphoric esters are tributyl phosphate, tri-2-ethylbutyl phosphate, tri-2-ethylhexyl phosphate, trichloroethyl phosphate, 2-ethylhexyl diphenyl phosphate, cresyl diphenyl phosphate, triphenyl phosphate, tricresyl phosphate and trixylenyl phosphate. Preference is given to tri-2-ethylhexyl phosphate and to Reofos® 50 and 95 (from FMC).

G) Chlorinated hydrocarbons (paraffin)

### H) Hydrocarbons

I) Monoesters, for example butyl oleate, phenoxyethyl oleate, tetrahydrofurfuryl oleate and alkylsulphonic esters.
J) Glycol esters, for example diglycol benzoates.

It is also possible to employ mixtures of different plasticizers.

Suitable plasticizers which can be used are also described in the above-mentioned Taschenbuck der Kunststoffadditive.

### Pigments

Suitable pigments are known to the skilled worker. Examples of inorganic pigments are TiO₂, carbon black, Fe₂O₃, Sb₂O₃, (Ti, Ba, Sb)O₂, Cr₂O₃, spinels, such as cobalt blue and cobalt green, Cd(S, Se), ultramarine blue. Preference is given to TiO₂, including its micronized form. Examples of organic pigments are azo pigments, phthalocyanine pigments, quinacridone pigments, perylene pigments, pyrrolopyrrole pigments and anthraquinone pigments. Further details are to be found in the above-mentioned Handbook of PVC Formulating.

A further embodiment of the invention relates to the use of a mixture which comprises the following components defined above:
b) A wax as obtained by the Fischer-Tropsch synthesis (FT-wax);
c) At least one partially or fully oxidized polyethylene wax;
d) Filling materials; and, optionally,
e) Further additives which are customary for the processing and stabilizing of chlorine-containing polymers;
   for the preparation of chlorine containing thermoplastic polymer compositions.

The present invention specifically provides for the use of the above-described mixture as granules, extrudate or paste for stabilizing a halogen-containing polymer or polymer recyclate. For the individual stabilizers and for the halogen-containing polymer itself, the preferences expressed above apply; similarly, one of the above-described additional constituents can be employed.

A particularly preferred embodiment of the invention relates to the use of the above-defined mixture for increasing the impact strength of chlorine containing thermoplastic polymer compositions, particularly for increasing the impact strength of PVC.

A further embodiment of the invention relates to a process for the preparation of chlorine containing thermoplastic polymer compositions, which comprises adding to the chlorine containing thermoplastic polymer
b) A wax as obtained by the Fischer-Tropsch synthesis (FT-wax);
c) At least one partially or fully oxidized polyethylene wax;
d) Filling materials; and, optionally,
e) Further additives which are customary for the processing and stabilizing of chlorine-containing polymers.

The mixture defined above can be added to the polymer in a known manner, the above mentioned components and, if desired, further additives being mixed with the halogen-containing polymer by using known machinery, such as mixers, compounders, extruders, mills and the like. In this context the components can be added individually or as a mixture or else in the form of so-called master batches.

The invention also relates to the polymer compositions comprising the mixture defined above. They can be processed into the desired form, such as granulates, by known methods. Examples of such methods are calendaring, extrusion, injection moulding, sintering or spinning, and also extrusion blow moulding or processing by the plastisol process. The polymer compositions can also be processed to foams.

The invention also relates to the use of the polymer compositions for preparing mouldings which can be prepared from halogen-containing polymer. The polymer compositions are suitable for semi-rigid and flexible formulations, for example for flexible formulations for wire sheathing and cable insulation. In the form of semi-rigid formulations, the polymer compositions are suitable for decorative films, foams, agricultural films, hoses, sealing profiles, office films, extruded profiles and sheets, flooring films and sheets, coated products and synthetic leathers, and also crash-pad sheets, e.g. for use in the automotive sector).

In the form of rigid formulations, the polymer compositions are suitable for hollow articles (bottles), packaging films (thermoform films), blown films, crash-pad sheets (cars), pipes, foams, heavy profiles (window frames), transparent wall profiles, construction profiles, sidings, fittings and apparatus enclosures (computers, domestic appliances) and also other injection-moulded articles.

Examples of the use of the polymer compositions are artificial leathers, flooring, textile coatings, wallpapers, coil coatings and under body protection for motor vehicles.

Examples of sinter applications of the polymer compositions stabilized in accordance with the invention are slush, slush mould and coil coatings.

The Examples below illustrate the invention in more detail without restricting it. As in the remainder of the description, parts and percentages are by weight unless stated otherwise.

This is to illustrate the preparation of a PVC-composition with a high amount of filling material:

### Materials and Methods

### Components

PVC: Solvin® 267 RC (Solvin) with a K value of 67, CaCO₃: Hydrocarb 95T® Omya, TiO₂: Kronos 2220 (Kronos), stabilizer: mixture of calcium stearate, zinc stearate, and internal lubricant: Baeropan® MC 90747 (Barlocher), FT-wax: Sasolwax® H1 (Sasol), oxidized LDPE: Luwax® OA 2 (BASF).

The components mentioned above are mixed in a kneader in the amounts mentioned in Table 1. The dry blend thus obtained is processed in an extruder (Berstorff ZE 25, 1992, capacity: 10.5 kW) to form profiles. These profiles are characterized by the methods listed in Table 2.

### Extruder Conditions

3.5 nozzle; temperature of draw-off rollers: 40° C.; gap between upper and middle rollers: 2.8 mm; draw-off speed: output+50%.

Temperature distribution in the extruder: 170°, 170°, 180°, 185° C.; rotational speed: 30 rotations per min.

The offtake installed directly before the nozzle. The PVC band is fed through the upper and middle rolls and with an adjustment of the gap (2.8 mm) between the rolls the band is light pressed. The band is then fed through the middle and under rolls. The gap is positioned in such a way that the band is not pressed further.

### Measurements

Gloss is measured with Micro Tri Gloss from Gardner according to DIN 67530, the results are without dimensions, the higher the value the more glossy the surface on the upper part of the band; Colour is measured with LUCI 100 on the upper part of the band; Impact strength: radius of 0.10 mm and 1 J pendulum according to DIN 53753:

TABLE 1

| | Composition 1 | Composition 2 |
|---|---|---|
| Components | [%] | [%] |
| PVC | 84.0 | 83.8 |
| CaCO₃ | 12.6 | 12.6 |
| TiO₂ | 0.4 | 0.4 |
| Stabilizer | 2.2 | 2.2 |
| FT-wax | 0.8 | 0.8 |
| Oxidized LDPE | | 0.2 |

### Results

### The Results are Listed in Table 2

TABLE 2

| | Composition | Composition |
|---|---|---|
| | 1 | 2 |
| Impact Strength [kJ/m²] | 5.7 | 6.7 |
| Output [m/min.] | 0.69 | 0.72 |
| Temperature of mass in | 185 | 185 |
| nozzle [° C.] | | |
| Pressure [bar] | 72 | 69 |
| Torque [Nm] | 21 | 22 |
| Contact angle (60°) | 4.8 | 4.5 |
| Yellowness (DIN 6167) | 14.45 | 14.69 |

### Measurement of Fusion Times

The fusion time, which has a linear dependency with the output, is investigated in a Brabender Plasti-Corder Lab-station (Type: 813402).

### Components

PVC: Solvin® 267 RC (Solvin) with a K value of 67, CaCO₃: Hydrocarb 95T® Omya, TiO₂: Kronos 2220 (Kronos), stabilizer: mixture of calcium stearate, zinc stearate, and internal lubricant: Baeropan® MC 90747 (Barlocher), FT-wax: Sasolwax® H1 (Sasol), oxidized LDPE: Luwax® OA 2 (BASF).

The components mentioned above are mixed in a kneader in the amounts mentioned in Table 3. The dry blend thus obtained is processed in Brabender Plasti-Corder Lab-station. The thermostat of the apparatus is set to 162° C. and the data collection by the software of the Plasti-Corder and the kneader in the Plasti-Corder are started. 60.0 g of dry-blend is introduced and a stop-watch is started at the same time. The data collection and the kneader are stopped after 15 min. The data are analyzed by the software. The obtained torque and fusion time values are summarized in Table 4.

TABLE 3

| | Composition | Composition | Composition | Composition | Composition | Composition | Composition |
|---|---|---|---|---|---|---|---|
| | 3 | 4 | 5 | 6 | 7 | 8 | 9 |
| PVC | 84.1 | 84.0 | 84.0 | 83.9 | 87.6 | 87.5 | 87.5 |
| CaCO₃ | 12.6 | 12.6 | 12.6 | 12.6 | 8.8 | 8.8 | 8.8 |
| TiO₂ | 0.4 | 0.4 | 0.4 | 0.4 | 0.4 | 0.4 | 0.4 |
| Stabilizer | 2.2 | 2.2 | 2.2 | 2.2 | 2.3 | 2.3 | 2.3 |
| FT-wax | 0.7 | 0.7 | 0.8 | 0.8 | 0.9 | 0.9 | 0.9 |
| Oxidized LDPE | | 0.1 | | 0.1 | | 0.1 | 0.2 |

TABLE 4

| | Composition | Composition | Composition | Composition | Composition | Composition | Composition |
|---|---|---|---|---|---|---|---|
| | 3 | 4 | 5 | 6 | 7 | 8 | 9 |
| Torque (Nm) | 30.5 | 29.6 | 27.8 | 25.1 | 28.5 | 27.0 | 26.4 |
| Fusion time (s) | 740 | 820 | 900 | 990 | 752 | 874 | 937 |

1. A composition which comprises
a) a chlorine containing thermoplastic polymer;
b) a wax obtained by Fischer-Tropsch synthesis (FT-wax); and
c) at least one partially oxidized polyethylene wax.

2. The composition according to claim 1, which further comprises
d) filling materials.

3. the composition according to claim 1, which further comprises
d) filling materials; and, optionally,
e) further additives which are customary for the processing and stabilizing of chlorine-containing polymers.

4. The composition according to claim 3, which comprises
a) 65.0-95.0 wt.-% of the chlorine containing thermoplastic polymer;
b) 0.01-2.0 wt.-% of the wax obtained by Fischer-Tropsch synthesis (FT-wax);
c) 0.01 to 0.5 wt.-% of the at least one partially oxidized polyethylene wax;
d) 5.0-35.0 wt.-% of the filling materials; and, optionally,
e) 0.01-30.0 wt.-% of the further additives which are customary for the processing and stabilizing of chlorine-containing polymers;
provided that the sum of the weight percentages of all components does not exceed 100%.

5. The composition according to claim 3, which comprises
a) 70.0-90.0 wt.-% of the chlorine containing thermoplastic polymer;
b) 0.01-1.5 wt.-% of the wax obtained by Fischer-Tropsch synthesis (FT-wax);
c) 0.01-0.3 wt.-% of the at least one partially oxidized polyethylene wax;
d) 5.0-25.0 wt.-% of the filling materials; and, optionally,
e) 0.01-10.0 wt.-% of the further additives which are customary for the processing and stabilizing of chlorine-containing polymers;
provided that the sum of the weight percentages of all components does not exceed 100%.

6. The composition according to claim 3, which comprises
a) 75.0-90.0 wt.-% of PVC or a recyclate thereof;
b) 0.01-1.0 wt.-% of the wax obtained by Fischer-Tropsch synthesis (FT-wax);
c) 0.01-0.2 wt.-% of the at least one partially oxidized polyethylene wax;
d) 7.0-20.0 wt.-% of the filling materials; and, optionally,
e) 0.01-10.0 wt.-% of the further additives which are customary for the processing and stabilizing of chlorine-containing polymers;
provided that the sum of the weight percentages of all components does not exceed 100%.

7. A method for preparing chlorine containing thermoplastic compositions comprising utilizing a mixture which comprises
b) a wax obtained by Fischer-Tropsch synthesis (FT-wax);
c) at least one partially oxidized polyethylene wax;
d) filling materials; and, optionally,
e) further additives which are customary for the processing and stabilizing of chlorine-containing polymers.

8. The method of claim 7 wherein the mixture increases the impact strength of chlorine containing thermoplastic polymer compositions.

9. The method of claim 8 wherein the chlorine containing thermoplastic compositions comprise PVC.

10. A process for the preparation of chlorine containing thermoplastic polymer compositions, which comprises adding to the chlorine containing thermoplastic polymer
b) a wax obtained by Fischer-Tropsch synthesis (FT-wax);
c) at least one partially oxidized polyethylene wax;
d) filling materials; and, optionally,
e) further additives which are customary for the processing and stabilizing of chlorine-containing polymers.
